(19) United States
(12) Patent Application Publication
(10) Pub. No.: US 2005/0046942 A1
(43) Pub. Date: Mar. 3, 2005

(54) Method and device for splitting and/or concentrating electromagnetic waves

(76) Inventors: Jens Haase, Mainz (DE); Thomas Paatzsch, Mainz (DE); Martin Popp, Mainz (DE)

Correspondence Address: SIMPSON & SIMPSON, PLLC, 5555 MAIN STREET, WILLIAMSVILLE, NY, 14221-5406, US

(21) Appl. No.: 10/490,008

(22) PCT Filed: Aug. 7, 2002
(86) PCT No.: PCT/DE02/02892

(30) Foreign Application Priority Data
Sep. 19, 2001 (DE) 101 46 010.4

(51) Int. Cl. G02B 5/30; G02B 27/28

(52) U.S. Cl. 359/495

(57) ABSTRACT

A method and apparatus for splitting a beam of electromagnetic waves comprising several wavelength components into a plurality of separate beams of discrete wavelengths (demultiplexing) comprises means for coupling and decoupling the beams and at least one filter impinged upon the beams at different angles of incidence. One objective is to provide devices for multiplexing and demultiplexing optical signals which can be produced economically and that require little space for greater suitability in microelectronics.

The present invention relates to a method and a device for the multiplexing and demultiplexing of electromagnetic waves. The present invention relates in particular to a method for splitting a beam of electromagnetic waves, containing components from several wavelengths, into a plurality of separate beams of discrete wavelengths (demultiplexing) and a corresponding device for this.

Moreover, the present invention also relates to a method for combining several beams, each having different electromagnetic wavelength components, into a single beam that comprises the different wavelength components (multiplexing), as well as a corresponding device.

Optical signal and data transmission and processing have become increasingly important in recent times. Above all, the high speed and the high data density that can be transmitted by optical methods, especially using fibre optics, are decisive for this. Therefore optical data transmission is mainly being relied on for the construction of fast data networks with large data capacity.

An optical data network with the full functionality of existing electrical data networks cannot, however, be restricted to data transmission from a starting point to a destination (where optoelectronic converters are generally provided, which on the one hand convert the signals produced in the conventional, electronic data processing equipment into optical signals and convert these optical signals back into electrical signals on arrival at a destination), but rather also comprises the coupling, splitting and distribution of various data streams in a complex network. So-called “multiplexers” and “demultiplexers” are essential components of a complex network of this kind. A multiplexer is a device in which several signals or data streams carried on separate lines are led into a single data line that has the capacity for the several combined data streams. Conversely, a demultiplexer is capable of splitting several data streams again that have been carried in a single data line, so that they run separately in several data lines and can thus be carried to different destinations. The data streams carried in a single line are generally called “channels”. In the conventional, electrical multiplex method, in which for example several data streams from slow transmission lines are combined in a high-speed line, the individual channels consist of time segments each assigned unambiguously to the data streams and the corresponding method is therefore called time division multiplexing. In the optical area it is possible to use several data channels in the form of electromagnetic waves of different wavelengths, which are carried in parallel and simultaneously by one optical data line, concretely an optical fibre. This method is called “wavelength division multiplexing” or “WDM” for short. The data information is thereby transmitted by modulation of the electromagnetic waves in the gigahertz region. The typical modulation frequencies are in the region of 2.5 and 10 GHz, up to 40 GHz, whereas the channel separation (average distance between adjacent channels) is between 0.8 and 1.6 nm, corresponding to a frequency separation of 100 or 200 GHz. The optical wavelengths used are generally in or near the visual region, e.g. at 1550 nm (nanometres), where the glass material usually employed has an attenuation minimum. Depending on the frequency separation used, the individual “channels” then comprise a very narrow wavelength range, of the order of 0.5 nm or less. Among other things this is associated with the fact that one would like to accommodate as many channels as possible near the attenuation minimum at 1550 nm, with good channel separation.

In order to be able to separate these densely packed frequency or wavelength channels from a corresponding optical signal beam that consists of several wavelength components, usually so-called “Fabry-Perot” interferometers are used. These comprise interference filters, [which have] a large number of layers of different refractive index with a thickness of ½ λ and ¼ λ. These Fabry-Perot interferometers operate as band-pass filters, with the bandwidth of the said band-pass filter substantially coinciding with the channel width of the optical signals. Accordingly, an optical signal consisting of several wavelength components can be directed onto several different band-pass filters in succession, with always only the channel defined by the relevant filter being allowed to pass through, whereas the other components of the optical signal are reflected. These are then directed onto further filters, which fulfil the transmission condition for another wavelength component of the signal. A corresponding demultiplexer is therefore relatively expensive, since the number of interferometric filters must correspond to the number of channels in a signal and because as a rule deflecting and diverting devices must also be provided for the signal components reflected from a filter in each case.

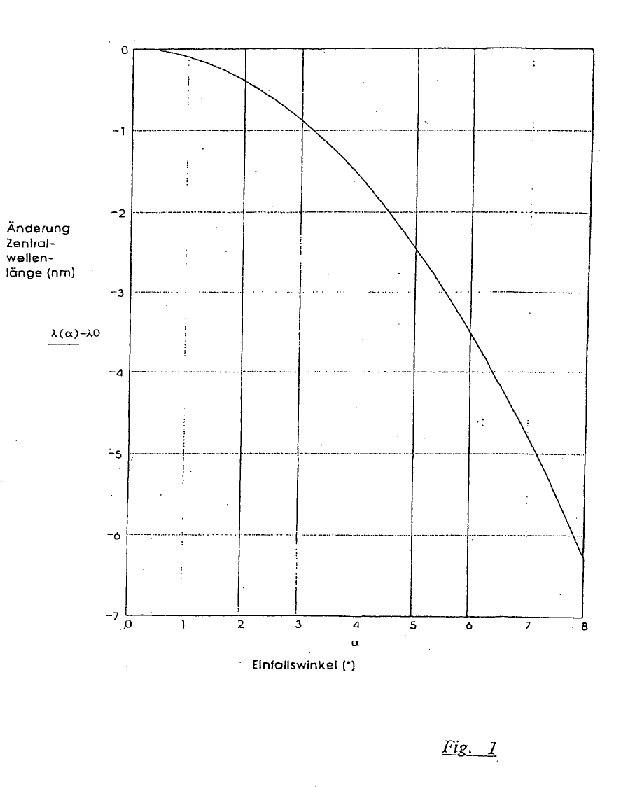

A demultiplexer is already known from U.S. Pat. No. 5,737,104, in which just a single interferometric filter of the Fabry-Perot type is used, with the individual channels of an optical signal stream consisting of several wavelengths being separated by collecting the reflected signal in each case by a collimator and introducing it into a fibre, with the fibre being returned in an arc back to the filter, to meet the filter at an angle that differs from the first angle of incidence, whereby the transmission condition for another wavelength channel is fulfilled. This mode of operation is based on the knowledge that the transmission wavelength for an interferometric band-pass filter of this kind depends on the angle of incidence of the optical signal beam on the filter surface. The corresponding relationship between transmission wavelength and angle of incidence is shown in FIG. 1. More precisely, FIG. 1 shows the variation of the central wavelength of the band allowed to pass through a filter as a function of the angle of incidence on the filter surface. It has to be borne in mind that e.g. with a channel separation of 100 GHz the filter allows wavelengths to pass that are within only about ±0.2 nm about the central wavelength. As can be seen from FIG. 1, at first the central wavelength only decreases slightly at small angles of incidence (deviation from the normal to the filter surface), with the drop becoming steeper and steeper for larger angles. It is therefore possible, by changing the angle of incidence of the optical signal beam, in each case to allow different channels of the optical signal to pass through the filter and accordingly couple them out at the back of the filter by means of an appropriate coupling-out device, concretely a collimator.

However, the system known from U.S. Pat. No. 5,737,104 has the disadvantage that it must catch the reflected components with a collimator and return them via a glass fibre, and to avoid optical losses the glass fibre must not be curved more than by a certain minimum bending radius. Such a demultiplexer therefore requires considerable space. The arrangement of several collimators for catching the respective reflected wavelength components also requires a corresponding amount of space. The corresponding multiplexer is almost identical in construction to a demultiplexer, with just the beam directions reversed, i.e. the wavelength components originating from different optical fibres are fed via collimators at different angles at the same position into the filter, transmitted appropriately at different angles and are caught via collimators and returned through glass fibres led back in the arc to the filter, so that finally they are reflected back in the very same collimator, which then couples out the combined signal into a common signal line. This may, however, result in considerable differences in optical path for the individual signal components.

Relative to this state of the art, the present invention is based on the problem of creating appropriate methods and appropriate devices for multiplexing and demultiplexing of optical signals, which can be produced relatively simply and inexpensively and at the same time take up only a small space and so are better suited for use in conjunction with microelectronics.

With respect to the method for demultiplexing, the problem on which the invention is based is solved by the following features:
a) Use of two filters, which have their partly reflecting, partly transmitting filter surfaces facing each other, but are arranged relative to one another in non-parallel alignment of the filter surfaces,
b) Directing of the beam with several wavelength components onto a first one of the filter surfaces at a first angle of incidence, at which the transmission condition is fulfilled for one of the wavelength components of the beam, and reflection of the other wavelength components at a first angle of emergence, which corresponds to the first angle of incidence, towards the second filter surface,
c) Arrangement of the first and second filter surfaces in such a way that the beam reflected at the first angle of emergence impinges on the second filter surface at a second angle of incidence, whereby the transmission condition for one of the wavelength components that remained in the beam reflected on the first filter surface is fulfilled and reflection of the other wavelength components at a second angle of emergence, which corresponds to the second angle of incidence, towards the first filter surface,
d) Repeating of steps b) and c) for the beam reflected on the second filter surface with further angles of incidence, for which in each case the transmission condition for one of the respective wavelength components that remained in the beam is fulfilled, and
e) if necessary (optionally) coupling out of the respective transmitted wavelength components by means of a coupling-out device.

According to this method, at most two filters are required, in order to separate in principle any number of channels from a given optical signal. In practice, however, this number is limited to about 4 channels, as the transmission curve of the filter is not a linear function of the angle of incidence. Moreover, the maximum angle of incidence is limited in practice to about 5° to 10°, so that angle α in general does not exceed a value of 4° to 6° either, and is for example between 2° and 3°. However, the process can be repeated with a subsequent further pair of filter surfaces for the reflected beam, which can for example contain an additional 4 or even more remaining channels apart from the channels already coupled out.

It is not necessary to catch the respective reflected components of the signal with a collimator and return them via optical fibres at a new angle of incidence, in which the transmission condition is fulfilled for a further component, but rather the provision of the second filter surface, which is arranged non-parallel to the first filter surface, offers the possibility that the component reflected from a first filter surface impinges on the second filter surface at a different angle, than it previously did on the first filter surface. The second filter surface once again allows a wavelength component to pass through and this is caught by means of a collimator and fed into a further fibre, whereas the other wavelength components are reflected back from the second filter surface onto the first filter surface and, because of the non-parallel arrangement of these filter surfaces, impinge there again at a new angle of incidence. We then merely have to adjust the relative slopes on the target surfaces of the two filters so that after each reflecting of the optical signal, on impingement on the respective opposite filter surface, the transmission condition is fulfilled for one more of the wavelength components remaining in the signal. The spacing of the filters is to be selected in such a way that the input beam passes the edge of the first filter without shading or diffraction and impinges on the opposite filter surface at a clear distance from the edge. Conversely, the reflected output beam should experience a last reflection at a clear distance from the filter edge and then pass the edge of the opposite filter at a sufficient distance. An advantage of this arrangement with small angles and distances that are as small as possible is that the beams reflected on the filters are relatively close together and yet the beam for threading and the output beam are sufficiently distant from the filters. In this way it is possible on the one hand to reduce the number of interferometric filters, but at the same time the number of collimators is also reduced, because the reflected wavelength components no longer have to be caught and returned via glass fibres, but impinge on an opposite filter surface directly.

Preferably the wavelength components, the filters and their arrangement are chosen such that always one of the wavelength components of the signal is allowed to pass through a filter automatically even with multiple reflections between the filters, until finally all wavelength components or channels have been coupled out, without having to alter anything in relation to the alignment of the filter surfaces. Generally the spacing of the wavelength components, i.e. of the individual channels, is precisely stipulated, so that it is only a question of selecting the channels, the filters and their arrangement. It is of course preferable to use flat filter surfaces, which are inclined to one another at an angle α, the angle α in any case being less than 90°, and preferably less than 20° and in particular less than 10°, and in practice angles in the range from 1° to 6° between the two flat filter surfaces appear to be the most suitable. Larger angles are certainly possible, but then only a few reflections between the filter surfaces are possible before a finally reflected beam leaves the space between the two filter surfaces on the divergent side of the filter surfaces that are inclined to one another. In that case the beam consisting of several wavelengths is preferably directed in a plane between the filter surfaces and onto a first filter surface, which is parallel to a plane which is spanned by the two normals to the flat filter surfaces. Optionally, a mirror can also be used, in order to allow the beam to impinge on one of the flat filter surfaces at a desired first angle of incidence. It is also conceivable that at the first impingement on a filter surface the transmission condition may not be fulfilled for any of the wavelength components of the beam, so that the latter is reflected completely and is directed onto the second filter surface, so that this second filter surface then assumes, as it were, the function of the first filter surface, as a wavelength component is transmitted and coupled out there for the first time.

In a preferred embodiment of the invention, two different filters are used, i.e. two filters that differ in their filter characteristics to the extent that the transmission condition for the same wavelength component is or would be fulfilled at different angles of incidence. This variant makes it possible to produce a symmetrical beam path, where the beam impinges on the first filter at a stipulated angle of incidence, is reflected from there onto the second filter and so on, with the angle of incidence becoming smaller at each reflection, finally reaching a minimum value and then reversing its sign, i.e. it becomes incident from the other side of the perpendicular and finally, at the end of the filters, emerges again from the space between the filters. The first angle of incidence and the angle between the flat filter surfaces can be set so that on the “return journey” of the beam, the angles of incidence on one filter surface are now the same as when they previously occurred on the respective opposite filter. It should be noted that the first angle of incidence γ fulfils the condition γ=(2n+1)α/2, where α is the angle between the filter surfaces. After each reflection, the angle of incidence on the next filter surface decreases relative to the angle of incidence and reflection on the preceding filter surface by the angle α, when the beam is led from the, open, divergent side of the filter plates between these and indeed in a plane or parallel to a plane that is spanned by the normals to the filter surfaces. In other words, if the first angle of incidence is γ, the angle of incidence on the opposite filter surface is γ−α and the beam reflected back there impinges on the first filter surface at a new angle of incidence γ−2α. With the said condition for the angle γ, the beam would finally impinge on the first filter surface at an angle α/2 and on the opposite second filter surface at an angle −α/2, where the minus sign means that the beam is now incident from the opposite side of the perpendicular than previously. In subsequent reflections, the angle of incidence then increases in value in each case by the value α, so that a beam path with mirror symmetry is obtained for the path of the beam to and fro, with the bisecting line of angle α as the plane of mirror symmetry.

In other words, each angle of incidence occurs twice, but each time on the opposite filter surface, so that it is preferable if a different wave component is transmitted and coupled out through both filters at this angle of incidence.

For this reason the filter materials ought to be different, and selected so that at one and the same, concretely occurring angle of incidence, which is an odd multiple of α/2, in each case a different channel is coupled out. The symmetrical beam path has the advantage that it is possible to use filters with different transmission wavelengths but the same angle characteristics.

Alternatively, however, it is also possible to provide identical filter types for both filters and choose an angle of incidence γ for them that deviates from the aforementioned condition. In general, the angle of incidence γ can be chosen such that it fulfils the condition γ=(cn+1)α/c, where c need not be an integer and is preferably in the range between 2 and 5. If we assume, for example, that c=3, and choose n=2 for the first angle of incidence, then the first angle of incidence and reflection is 7/3 α, on the opposite side the second angle of incidence is 4/3 α and again on the first filter the angle of incidence is ⅓ α. At the next reflection, the beam has already reversed its direction and impinges on the second filter surface at an angle of ⅔α (from the other side of the perpendicular), on the first filter surface at an angle of 5/3α and finally once again on the second filter surface at an angle of 8/3 α. Even if the filter materials and/or filter surfaces are of identical construction, with this choice of angle of incidence the transmission conditions on both filter surfaces, at each reflection and/or each impingement of the beam can nevertheless occur for a different wavelength and/or a different wavelength channel, since the angles of incidence always differ by at least ⅓ α and sometimes even by ⅔ α.

The corresponding device according to the invention for multiplexing/demultiplexing of beams of electromagnetic waves, which comprise several wavelength components, firstly has, in keeping with the state of the art, devices for coupling-in and coupling-out of the beams and at least one filter, on which the beams impinge at different angles of incidence. To solve the problem posed above, with respect to the device a second filter is provided, with its filter surface arranged roughly opposite the first filter, but not parallel to it, so that a beam incident on one of the filter surfaces at an angle of incidence (γ) that can be stipulated, is reflected either completely or partially onto the opposite filter surface and impinges at a second angle of incidence, which is different from the first angle of incidence, and which depends on the alignment of the filter surfaces on the points of impingement of the beams, with coupling-in and coupling-out devices being provided at the transmission points for the beams that pass through the filter.

The device according to the invention is equally suitable for multiplexing as for demultiplexing. First the beam, which consists of several wavelength components and generally emerges from an optical fibre and is collimated by a collimator, is directed onto one of the filter surfaces at a specially chosen angle of incidence γ, with the transmission condition for one of the components of the beam being fulfilled at this angle. The transmitted light is caught by a collimator on the back of the filter and is, for example, fed back into another optical fibre. This also occurs at all further points of reflection of the two filter surfaces, with a component (a wavelength channel) of the beam also passing through the filter surface at each point of reflection. Conversely, however, the output lines or output fibres can also be used as input fibres and can be coupled-in via a collimator with one wavelength in each case, the collimator having its optical axis aligned so that the emerging beam with the fixed wavelength component passes through the filter and therefore enters the space between the two filters and is reflected there, until it finally impinges on a collimator that is in the same place where previously the coupling-in collimator was provided, but where the beam now emerges. At the same points of reflection as previously, coupling-in devices are provided in each case for the corresponding wavelengths, so that on the whole the various wavelength components are superimposed and run along the same path towards the coupling-out collimator, as previously in the opposite direction, i.e. a coupling-in collimator was provided instead of the coupling-out collimator.

In the device according to the invention, narrow band-pass filters are preferably provided, e.g. filters with λ/2 and λ/4 layers, which operate by the Fabry-Perot principle. The filter surfaces are arranged at an angle of less than 90° to one another, and the angle between the two filter surfaces is preferably between 1° and 10°. If too small an angle is chosen between the flat filter surfaces, the angle of incidence must not also be very small, because otherwise there are too many reflections between the filter surfaces and the coupling-out collimators are then too close together because of the ever decreasing distances between the successive reflection and/or transmission points of the same side of the filter. Otherwise it would be necessary to choose a relatively large distance between the filter surfaces, though this too is a disadvantage, because then the desired compactness and space saving is not achieved. If the chosen angle of incidence is too large, either there are only a few reflections or larger filter surfaces are required, and adjustment of the corresponding collimators and fibres becomes difficult in the case of beams that impinge on the filters at a very flat angle. Furthermore, the distances between the transmission points are then very varied. Generally, therefore, the angle between the plates will be set to a value between 1° and 6°, e.g. 3°, and as a rule the first angle of incidence is not substantially greater than three to four times the semi-angle between the plates, for example 4.5°. The separation of the filter surfaces can then be in the region of a few (5-10) mm and the dimensions of the filter surfaces are typically 1.5×1.5 mm² to 1×1 mm². Filter thickness is usually about 1 mm.

The optical axes of all collimators for coupling-in and/or coupling-out are preferably in one and the same plane, which is parallel to a plane that is spanned by two intersecting normals on the filter surfaces.

Optionally, different or even identical filter types can be used for the two filter surfaces, and the choice of filter types also determines the angles of incidence, i.e. the alignment of one or more coupling in collimators.

Further advantages, features and possible applications will become clear from the following description of preferred embodiments and the associated diagrams, showing:

FIG. 1 the deviation of the central wavelength of the radiation that passed through a Fabry-Perot filter as a function of the angle of incidence of the radiation,

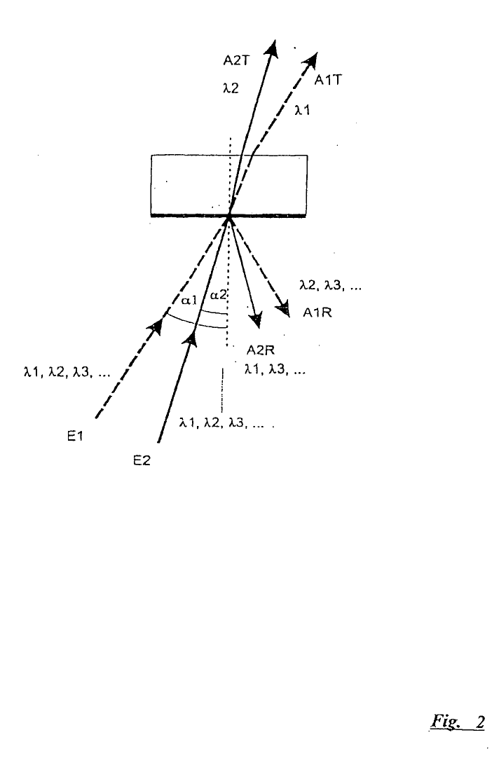

FIG. 2 the functional principle of double use of a filter based on the filter property according to FIG. 1,

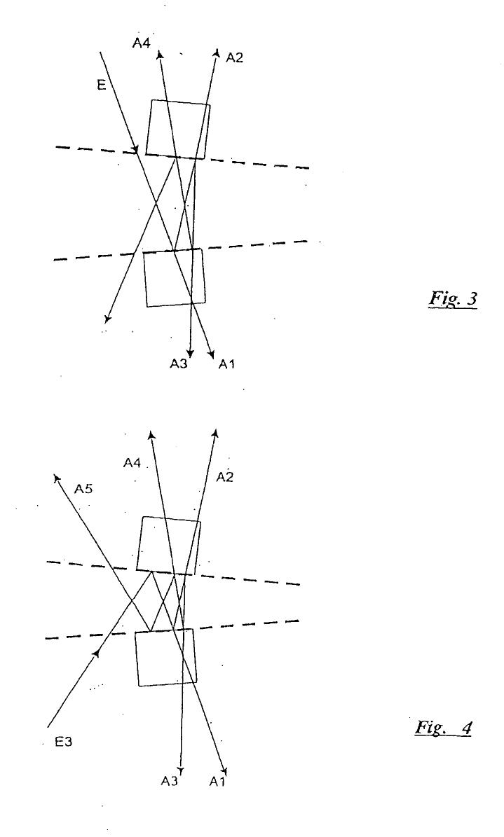

FIG. 3 arrangement of two filters with a first symmetrical beam path and four coupled-out beams with one input beam,

FIG. 4 another symmetrical beam path with one input beam and five output beams,

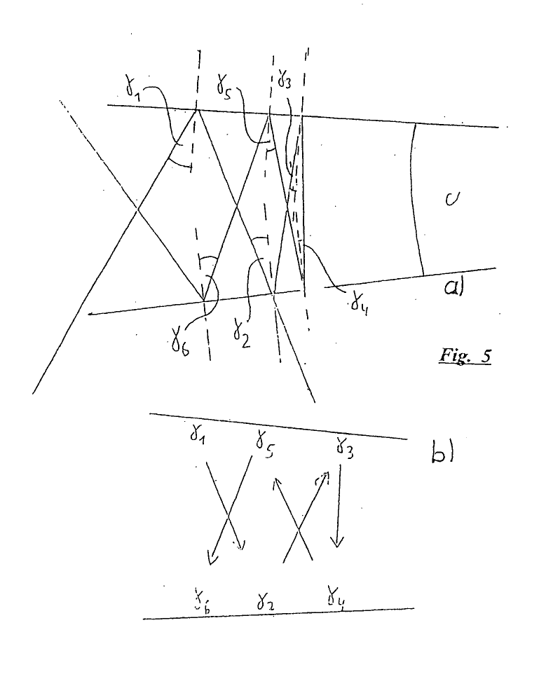

FIGS. 5 and 5a magnified even further, a beam path as in FIG. 4 indicating the individual angles and in FIG. 5b a reflection diagram with the indicated angles of reflection,

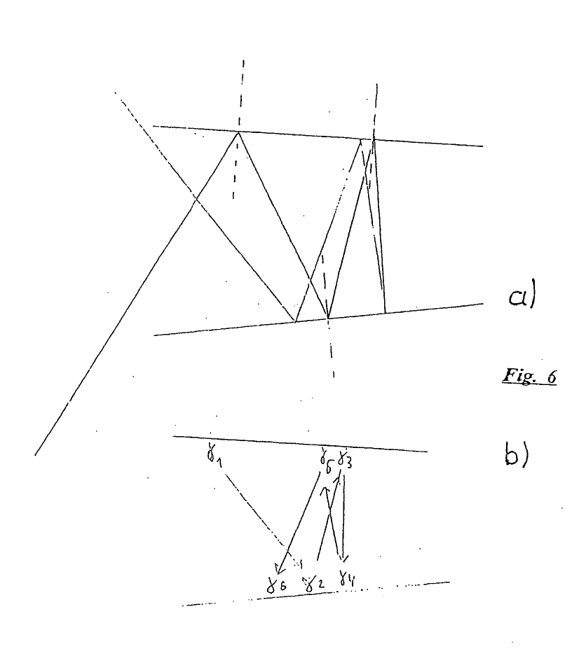

FIG. 6a an asymmetric beam path and

FIG. 6b schematic representation of the respective angles of incidence,

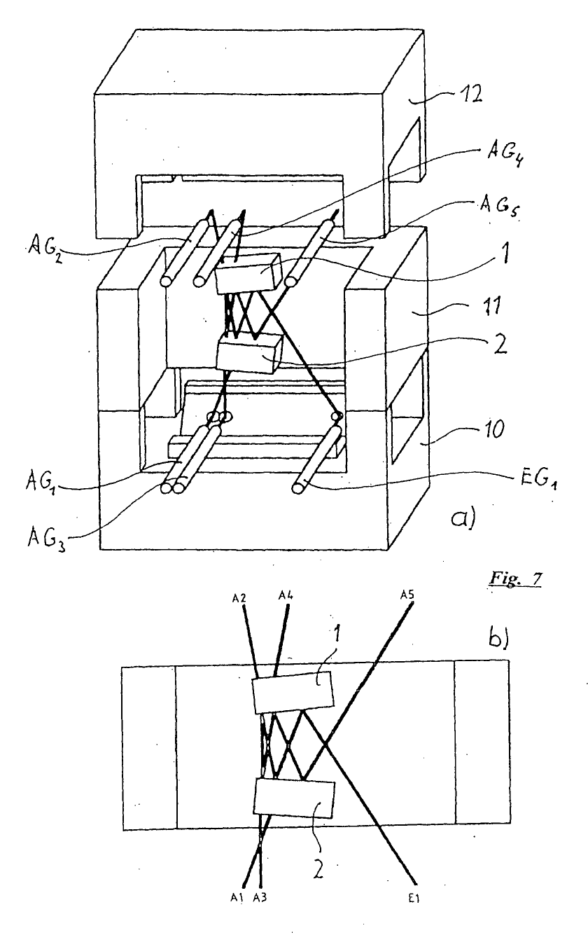

FIG. 7a perspective view of a multiplexing/demultiplexing device, represented schematically,

FIG. 7b the associated reflection and coupling-out diagram, and

FIG. 8 two successive pairs of filters

FIG. 1 shows, as already mentioned, the dependence of the angle of the central wavelength of a pass band of a band-pass filter on the angle of incidence of the radiation. This representation is valid for an optical band-pass filter that operates according to the Fabry-Perot principle. It shows the difference of the wavelengths λ(α)-λ(0), from which it can be seen that as the angle of incidence increases, the transmission condition is fulfilled for shorter wavelengths. When using infrared light with a wavelength of about 1550 nm, the band pass has a typical bandwidth of 0.4 nm.

FIG. 2 shows how a filter can accordingly be put to double use, in that two input beams E1 and E2, each of which consists of wavelength components of wavelengths λ1, λ2 and λ3, can be directed at different angles α1 and α2 onto the filter surface, and in the case of the larger angle of incidence α1 the wavelengths λ2 and λ3 are reflected but the beam of wavelength λ1 passes through the filter, whereas at the smaller angle of incidence α2 the components with wavelengths λ1 and λ3 are reflected, whereas the wavelength λ2 passes through. According to the state of the art, for example, the component reflected at angle α1 was redirected onto the filter surface, now at an angle α2, so that the same exit beams A1T and A2T are therefore obtained, and the remaining beam, which still contains the wavelength λ3, was either passed on directly on reflection into a corresponding collimator and from there for further use, or alternatively this component, if it also contained additional wavelengths, was led again onto the filter at an angle α3. This principle of multiple use of a filter is accordingly already known. FIG. 3 shows a first example of the double use of two filters, where the filters are inclined to one another at a small angle α and an input beam, from the open, divergent side, enters the region between the two filters, impinges on the lower filter at a first angle of incidence, with component A1 passing through, whereas the rest is reflected and, now at a second angle of incidence, which is reduced relative to the first angle of incidence by the angle α between the two filter surfaces, impinges on the upper filter surface. In the variant shown, this second angle of incidence is precisely half as large as the angle α between the filter surfaces, so that at the next reflection on the lower filter the angle of incidence is again reduced by a and is therefore −α/2, i.e. in absolute value also α/2, but is incident from the other side of the perpendicular than the reflections mentioned previously. For the second reflection, the condition for transmission is fulfilled for a wavelength component A2 and, since the two filters have different characteristics, on reflection at an angle α/2 on the lower filter, transmission is fulfilled for a further component A3. Finally, a component A4 passes through at the upper filter if the angle of incidence there is 3/2 α, just as in the case of the incident beam E on the lower filter. As can be seen, the beam path is absolutely symmetrical and all beams could also be reversed exactly with appropriate coupling-in devices, in order to make a single output component from the four wavelength components A1, A2, A3 and A4, and this would proceed as the output beam in the direction of beam E that proceeds here as the input beam.

Once again, FIG. 4 shows an entirely similar beam path, except that here the first angle of incidence γ was chosen to be much larger and at the first impingement on the upper filter there is no transmission, but exclusively a reflection, as the transmission condition is not fulfilled for any of the components contained in beam E3. At each reflection the angle of incidence is decreased by the value α, which corresponds to the value between the two filters, and from the symmetrical course of the beam travelling from left to right and then back again it can be seen that the first angle of incidence was precisely 5/2 α, so that the last reflected angle of incidence, at which beam A5 is reflected simultaneously at the lower filter, also corresponds to the first angle of incidence and/or reflection of beam E3. Again it is preferable to select different filter materials or filter characteristics, because the beams at the upper and at the lower filter each impinge at the same angles, so that otherwise it would not be possible to extract more than just two components. On account of the larger angle of incidence, in this embodiment, in comparison with that according to FIG. 3, the distance between the filter surfaces can be reduced, which has various advantages with respect to physical dimensions, the length of the beam path and the spacing of the coupled-out beams.

FIG. 5a shows, again in principle, the same picture as FIG. 4, but now the individual angles are designated exactly as γ1 to γ6. This means basically that the difference is γₙ-γₙ₋₁=α, and it should be noted that the angles γ4, γ5 and γ6 are negative angles of incidence relative to the angles γ1, γ2 and γ3, because there the beam is incident from the opposite side of the perpendicular relative to angles γ1 to γ3. In terms of absolute value, the angles γ3 and γ4, the angles γ2 and γ5 and the angles γ1 and γ6 are equal in each case, and accordingly the filter materials or the filter characteristics of the two filters should be different, so that different components are filtered out or transmitted even though the angles of incidence are equal (in absolute value).

FIG. 6a shows an asymmetric beam path and FIG. 6b once again illustrates the scheme of the sequence of angles of incidence γ1 to γ6, again with a change of sign between γ3 and γ4 and also basically with the condition that γₙ-γₙ₋₁=α. Here, however, angle γ is not chosen as an odd-number multiple of α/2, so that angles γ3 and γ4 are not equal in absolute value, but γ4 is smaller than γ3, and could for example be half of γ3. γ3 would then have the value ⅔ α and γ4 would have the value ⅓ α, in absolute value. The values of γ1 to γ6 are then all different from one another, i.e. they differ by at least ⅓ α or by ⅔ α, so that no pairs of equal angles arise, as in the case of the symmetrical embodiments in FIGS. 3 to 5. Therefore identical filters can be used and yet different wavelength components are coupled-out at each of the reflection points, if a component fulfils the transmission condition there.

FIG. 7a shows in perspective, and more or less schematically, the construction of a corresponding device, and FIG. 7b is a side view of the beam path, which also corresponds substantially to the beam path according to FIG. 4. We can see an input glass fibre EG1, which ends in front of a collimator mirror, which directs the light beam emerging from glass fibre EG1 onto the bottom surface of a filter 1. There, the light beam E1 is only reflected downwards and impinges at a new angle of incidence on the surface of the lower filter 2, where the transmission condition is fulfilled for beam A1, which impinges on a collimator mirror that is arranged directly in front of the entry surface of glass fibre AG1 and couples-in the beam with the corresponding wavelength component into the glass fibre AG1. The component reflected at the lower filter 2 is led upwards onto the surface of filter 1, where the angle of incidence is once again reduced by the angle α, so that the transmission condition is fulfilled here for the wavelength component A2, which is again coupled-in via a collimator mirror into glass fibre AG2. This process continues, with further components A3 and A4 being led into the output glass fibres AG3 or AG4 and finally the remaining reflected beam, which preferably now consists of just one single remaining wavelength component A5, is also coupled-in, into the output glass fibre AG5.

The two filters 1 and 2, as well as the glass fibres EG1, AG1 to AG5 and the corresponding collimator mirrors, are fixed in the housing, and the top part 12 of the housing 10, 11, 12 is only shown raised so that the individual glass fibres can be seen more easily.

FIG. 8 shows an embodiment of the invention in which two of the assemblies already described in connection with FIGS. 3 to 7 are mounted in series. In this way it is possible for example to separate eight different channels from the input beam E, and the filter characteristics of the filters, four in total, are tuned to the angles of incidence, determined by the beam positioning and relative inclination of the filter surfaces, so that in each case the transmission condition is fulfilled for another channel.

The input beam E first impinges on filter 1, at an angle of incidence at which the transmission condition is fulfilled for one channel or output beam Al, whereas all other components or channels are reflected. Then channels A2, A3 and A4 are coupled out on the surfaces of filters 1 or 2, until the finally reflected beam again emerges from the region between the two filters 1 and 2, and then impinges again on a third filter 3, which in its turn is arranged in such a way that now the transmission condition is fulfilled for a channel A5 and the still remaining components or channels are reflected; in the same way as was previously the case between filters 1 and 2. Either the filter characteristics or the angles of incidence between filters 3 and 4 differ relative to the characteristics or angles between filters 1 and 2, so that in fact the transmission conditions are in each case fulfilled for different channels A5 to A8 than in the case of channels A1 to A4. The angle between the pair of filters 1, 2 can differ from the angle between the pair of filters 3, 4, but it can also be identical, especially if the filter characteristics of filters 3, 4 differ from those of filters 1, 2.

In this case it is possible, as shown, for the surfaces of filters 1, 4 to be aligned parallel (but opposite) just as the surfaces of filters 2, 3. The angle of incidence for the transmitted beam A5 on filter 3 is then necessarily identical to the exit angle of the beam reflected last on filter 2, at which the transmission condition was fulfilled for channel A4. This shows conclusively that the filter characteristics of filters 2 and 3 must be different, and indeed in such a way that, with the same angle of incidence shown, different channels are allowed to pass through filters 2 and 3. As the beam positioning in the example of application in FIG. 8 is again chosen precisely so that the angle of incidence of the input beam E is five times the angle between filters 1, 2 and the filters 3, 4 enclose the same angle α as filters 1, 2, filters 1 and 4 must also have different characteristics and moreover filters 1 and 3 and filters 2 and 4 must in their turn have different characteristics, so that at the same angle of incidence, in each case a different channel fulfils the transmission condition. As can be seen, in fact with the arrangement shown, in all only two different angle of incidence arise, which are repeated on all filters, so that for channel separation all four filters must necessarily have different filter characteristics. This device can of course be used equally as a multiplexer or demultiplexer, like the embodiments described previously.

1. A method for splitting a beam of electromagnetic waves, which has components of several wave-lengths, into a plurality of separate beams of discrete wavelength (demultiplexing), comprising the steps of:
a) providing a plurality filters, which are arranged with their partly reflecting and partly transmitting filter surfaces facing one another, but with non-parallel alignment of the filter surfaces to one another,
b) directing the beam with several wavelength components onto a first one of the filter surfaces at a first angle of incidence, at which the transmission condition is fulfilled for one of the wavelength components of the beam, and reflection of the remaining wavelength components at a first angle of emergence, which corresponds to the first angle of incidence, towards the second filter surface,
c) arranging the first and second filter surfaces in such a way that the beam reflected at the first angle of emergence impinges on the second filter surface at a second angle of incidence, at which the transmission condition is fulfilled for one of the wavelength components remaining in the beam reflected at the first filter surface and reflection of the remaining wavelength components at a second angle of emergence, which corresponds to the second angle of incidence, towards the first filter surface,
d) repeating steps b) and c) for the beam reflected at the second filter surface with further angles of incidence, for which in each case the transmission condition is fulfilled for one of the wavelength components remaining in each case in the beam, and
e) if necessary, coupling-out of the respective transmitted wavelength components by means of a coupling-out device.

2. The method according to claim 1, wherein the wavelength components, the filters and their arrangement are selected in such a way that the arrangement of the filters in step d) remains unchanged relative to steps b) and c).

3. The method according to claim 1 wherein said flat filter surfaces are used, which together enclose an angle (α) of less than 90°, and the enclosed angle is less than 60°.

4. The method according to claim 1, wherein the filter surfaces are arranged relative to one another at an enclosed angle (α) between 1° and 10°.

5. The method according to claim 3, wherein the beam is directed onto a first filter surface in a plane parallel to the plane spanned by the normals to the filter surfaces.

6. The method according to claim 1 the different filters are used, for which the transmission condition is fulfilled for equal wavelengths at different angles of incidence.

7. The method according to claim 6, wherein the beam for coupling-out a first wavelength component is directed onto the first filter surface at an angle of incidence γ, which fulfils the condition γ=(2n+1)α/2, where α is the angle enclosed between the filter surfaces.

8. The method according to claim 3, wherein the filter materials, the angle of incidence (γ) and the setting angle (α) between the filter surfaces are selected in such a way that, in the case of the first filter, transmission conditions are fulfilled for wavelength components of the beam when these are incident at an angle of incidence of I γ-2nα I (with n=0, 1, 2 . . . ), whereas in the case of the second filter the transmission conditions are fulfilled for wavelength components of the beam when the beam impinges at an angle I γγ−(2n+1)α I, (n=0,1,2 . . . ).

9. The method according to claim 1, wherein identical filters are used, and the angle of incidence fulfils the condition γ≠(2n+1)α/2.

10. The method according to claim 9, wherein the angle of incidence γ=(cn+1}α/c, (c>2, n=0,1,2 . . . ), where c is between about 2.5 and about 5.

11. A method for combining several beams of electromagnetic waves of different wavelengths (multiplexing), by the steps, which comprise providing filters for the electromagnetic waves arranged with their filter surfaces opposite one another, but not parallel to one another, where the beams are directed onto the back of the filters, for which the transmission condition of the wavelength of the beam in question is fulfilled with the filter in question, wherein said beams lie in a common plane and the points of impingement of the beams on the back of the filters are selected so they coincide with the points of reflection of a beam transmitted or also reflected there, originating from the opposite side of the filter, and selecting the angle between the opposite filter surfaces so that the angle of reflection of the beam originating from an opposite filter surface coincides with the angle of transmission of the beam coupled-in at the point of reflection.

12. A device for multiplexing/demultiplexing beams of electromagnetic waves, which comprise several wavelength components with devices for coupling-in and coupling-out of the beams and with at least one first filter on which the beams impinge at different angles of incidence, a second filter, with its filter surface arranged approximately opposite the first filter, but not parallel to its filter surface, so that a beam that is incident on one of the filter surfaces at an angle of incidence that can be stipulated, is either transmitted completely or partly through the filter or is reflected, and the reflected beam impinges on the opposite filter surface at a second angle of incidence, which is different from the first angle of incidence and which depends on the relative alignment of the filter surfaces at the points of impingement of the beams, and coupling-out and coupling-in devices for the transmitted beams at the points of transmission.

13. The device according to claim 12, wherein the filters are band-pass filters, which at a given angle of incidence allow wavelengths to pass within a narrow band of frequencies or wavelengths.

14. The device according to claim 12, wherein the filter surfaces are arranged at an enclosed angle that is less than 90°.

15. The device according to claim 14, wherein the angle enclosed between the filter surfaces is between about 1° and about 15°.

16. The device according to claim 12, wherein the coupling-in and coupling-out devices in a common beam plane run in or parallel to a plane that is spanned by the normals to the two filter surfaces.

17. The device according to claim 15 wherein coupling-in and coupling-out devices are arranged with their optical axis at an angle (γ) relative to the filter surfaces which fulfill the condition γ=(2n+1)α/2, where α is the angle between the filter surfaces, and the filters have transmission conditions for the same wavelengths at different angles of incidence.

18. The device according to claim 15 wherein the two filters have substantially identical filter properties, and the coupling-in and coupling-out devices are arranged with their optical axis at angles relative to the filter surfaces that fulfill the condition γ=(cn+1)α/c, where c is in the range from about 2.5 to 5.

19. The device according to claim 12 wherein two pairs of filters are arranged one after another in the beam path so that way that the second pair of filters receives-the output beam finally reflected from the first pair of filters in order to couple-out the channels remaining in the output beam on the second pair of filters similarly to the first pair of filters.
